(19) United States
(12) Patent Application Publication
(10) Pub. No.: US 2005/0221162 A1
(43) Pub. Date: Oct. 6, 2005

(54) Catalyst structures for electrochemical fuel cells

(76) Inventors: Stephen A. Campbell, Maple Ridge (CA); Michael V. Lauritzen, Burnaby (CA); Ping He, Richmond (CA); Paul D. Beattie, Port Moody (CA); Siyu Ye, Burnaby (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/816,210

(22) Filed: Apr. 1, 2004

(51) Int. Cl. H01M 4/86; H01M 4/90; H01M 4/96; H01M 8/10; H01M 2/00; H01M 2/02; H01M 2/14; C25C 7/02; C25B 11/03; C25D 17/12

(52) U.S. Cl. 429/44; 429/30; 429/33; 429/40; 429/41; 429/38; 429/39; 204/283

(57) ABSTRACT

Corrosion at the cathode catalyst may be a serious problem compromising fuel cell lifetimes. However in providing for increased corrosion resistance, an expected trade-off may occur regarding fuel cell performance. TKK (Tanaka Kikenzoku Kogyo) has solved this problem by providing both increased corrosion resistance with no concomitant loss in performance with their catalysts TEC50EA10 and TEC50BA10. An alternative to the TKK catalysts is to use an admixture of platinum black and supported catalyst and in particular, an admixture comprising 30-40% by weight platinum black and 60-70% by weight supported catalyst.

### BACKGROUND OF THE INVENTION

1. Field of the Invention

The present invention relates to catalysts for electrochemical fuel cells and more particularly to a support material for the catalyst.

2. Description of the Related Art

Fuel cell systems are currently being developed for use as power supplies in numerous applications, such as automobiles and stationary power plants. Such systems offer the promise of economically delivering power with environmental and other benefits. To be commercially viable however, fuel cell systems need to exhibit adequate reliability in operation, even when the fuel cells are subjected to conditions outside the preferred operating range.

Fuel cells convert reactants, namely fuel and oxidant, to generate electric power and reaction products. Fuel cells generally employ an electrolyte disposed between two electrodes, namely a cathode and an anode. A catalyst typically induces the desired electrochemical reactions at the electrodes. Preferred fuel cell types include polymer electrolyte membrane (PEM) fuel cells that comprise an ion-exchange membrane as electrolyte and operate at relatively low temperatures.

A broad range of reactants can be used in PEM fuel cells. For example, the fuel stream may be substantially pure hydrogen gas, a gaseous hydrogen-containing reformate stream, or methanol. The oxidant may be, for example, substantially pure oxygen or a dilute oxygen stream such as air.

During normal operation of a PEM fuel cell, fuel is electrochemically oxidized at the anode catalyst, typically resulting in the generation of protons, electrons, and possibly other species depending on the fuel employed. The protons are conducted from the reaction sites at which they are generated, through the ion-exchange membrane, to electrochemically react with the oxidant at the cathode catalyst. The catalysts are preferably located at the interfaces between each electrode and the adjacent membrane.

PEM fuel cells employ a membrane electrode assembly (MEA), which comprises an ion-exchange membrane disposed between two fluid diffusion layers. Separator plates, or flow field plates for directing the reactants across one surface of each fluid diffusion layer, are disposed on each side of the MEA.

Each electrode contains a catalyst layer between the respective fluid diffusion layer and the ion-exchange membrane, comprising an appropriate catalyst, which is located next to the ion-exchange membrane. The catalyst may be a metal black, an alloy or a supported metal catalyst, for example, platinum on carbon. The catalyst layer typically contains an ionomer, which may be similar to that used for the ion-exchange membrane (for example, up to 30% by weight Nafion® brand perfluorosulfonic-based ionomer). The catalyst layer may also contain a binder, such as polytetrafluoroethylene (PTFE).

The electrodes may also contain a substrate (typically a porous electrically conductive sheet material) that may be employed for purposes of reactant distribution and/or mechanical support. This support may be referred to as the fluid diffusion layers. Optionally, the electrodes may also contain a sublayer (typically containing an electrically conductive particulate material, for example, finely comminuted carbon particles, also known as carbon black) between the catalyst layer and the substrate. A sublayer may be used to modify certain properties of the electrode (for example, interface resistance between the catalyst layer and the substrate).

For a PEM fuel cell to be used commercially in either stationary or transportation applications, a sufficient lifetime is necessary. For example, 5,000 hour operations may be routinely required. In practice, there are significant difficulties in consistently obtaining sufficient lifetimes as many of the degradation mechanisms and effects remains unknown. Accordingly, there remains a need in the art to understand degradation of fuel cell components and to develop design improvements to mitigate or eliminate such degradation. The present invention fulfills this need and provides further related advantages.

### BRIEF SUMMARY OF THE INVENTION

Corrosion at the cathode catalyst may be a serious problem compromising fuel cell lifetimes. However in providing for increased corrosion resistance, an expected trade-off may occur regarding fuel cell performance. TKK (Tanaka Kikenzoku Kogyo) has solved this problem by providing both increased corrosion resistance with no concomitant loss in performance with their catalysts TEC50EA10 and TEC50BA10. An alternative to the TKK catalysts is to use an admixture of platinum black and supported catalyst.

In particular, a membrane electrode assembly for an electrochemical fuel cell may comprise: an anode and a cathode fluid diffusion layer; an ion-exchange membrane interposed between the fluid diffusion layers; an anode catalyst layer interposed between the anode fluid diffusion layer and the ion-exchange membrane; and a cathode catalyst layer interposed between the cathode fluid diffusion layer and the ion-exchange membrane. The cathode catalyst layer comprises an admixture of 30-40% by weight platinum black and 60-70% by weight supported catalyst.

These and other aspects of the invention will be evident upon reference to the following detailed description.

### DETAILED DESCRIPTION OF THE INVENTION

In operation, the output voltage of an individual fuel cell under load is generally below one volt. Therefore, in order to provide greater output voltage, numerous cells are usually stacked together and are connected in series to create a higher voltage fuel cell stack. Fuel cell stacks can then be further connected in series and/or parallel combinations to form larger arrays for delivering higher voltages and/or currents.

However, fuel cells in series are potentially subject to voltage reversal, a situation in which a cell is forced to the opposite polarity by the other cells in the series. This can occur when a cell is unable to produce the current forced through it by the rest of the cells. Groups of cells within a stack can be driven into voltage reversal by other stacks in an array. Aside from the loss of power associated with one or more cells going into voltage reversal, this situation poses reliability concerns. Undesirable electrochemical reactions may occur, which may detrimentally affect fuel cell components. For example, carbon corrosion can occur as follows:
C+2H₂O→CO₂+4H⁺+4e⁻ (1)

The catalyst carbon support in the anode structure corrodes, with eventual dissolution of the platinum-based catalyst from the support, and the anode fluid diffusion layer may become degraded due to corrosion of the carbon present in the fluid diffusion layer structure. In cases where the bipolar flow field plates are based upon carbon, the anode flow field may also be subjected to significant carbon corrosion, thereby resulting in surface pitting and damage to the flow field pattern.

However, corrosion is not limited to the anode and may also occur at the cathode. In particular, significant corrosion rates have been seen on different cathode catalyst structures. For example, ex situ results on a fluid diffusion electrode having a cathode catalyst comprising 40% Pt on a Vulcan XC72R carbon support showed a rate of carbon loss at 1.42 V of 1650 mg/day. Another similar trial using a cathode catalyst comprising 40% Pt on a Shawinigan carbon support, showed a rate of carbon loss at 1.42 V of 1260 mg/day.

Table 1 below summarizes the observed loss of platinum surface area after subjecting fluid diffusion electrodes with different catalyst structures to an oxidation current.

TABLE 1

| Catalyst | | Pt | Carbon | Loss of Pt |
|---|---|---|---|---|
| supplier | Catalyst | loading | support | surface area |
| Johnson | HiSpec 4000 | 39.1% | Vulcan XC72R | 80% |
| Matthey | | | | |
| Tokai carbon/ | TB #3845 | 40.7% | Graphitised | No loss |
| SAC | carbon | | Vulcan | |
| Johnson | — | 40% | Shawinigan | 64% |
| Matthey | | | | |
| Timcal carbon/ | SHAG 300 | 36.5% | HSA graphite | 46% |
| SAC | carbon | | | |
| TKK | TEC10EA50E | 46.2% | Graphitised | 51% |
| | | | carbon | |
| TKK | TEC10BA50E | 47.7% | Graphitised | 31% |
| | | | carbon | |

From Table 1 it can be seen that catalysts with Shawinigan and graphitised carbon demonstrated significantly greater corrosion resistance than catalysts with Vulcan XC72R. Both the catalyst material and the electrode structure affect the carbon corrosion rate. Further, the most stable carbon support is a graphitised Vulcan from Tokai Carbon.

The corrosion resistance of carbons may be related to the degree of the graphitic nature within the structure. The more graphitic the structure of the carbon the more resistant the carbon is to corrosion. Carbon blacks employed in fuel cells, either as the electrocatalyst support or in the fluid diffusion layer, may therefore be those that are partially or fully graphitised. In addition or alternatively, the electrocatalyst support can be made more resistant to corrosion by increasing the catalyst loading relative to the support loading. The catalyst may thus protect the underlying carbon support from corrosion. In particular, the electrocatalyst may be greater than 60% metal catalyst on carbon, for example between 70 and 80% metal on carbon. However, the effective surface area of the catalyst may be reduced in catalyst structures with such high relative amounts of catalyst thereby resulting in poorer fuel cell performance. The difficulty is in obtaining a cathode catalyst resistant to corrosion without sacrificing such fuel cell performance.

Table 2 summarizes the cathode carbon loss and performance loss in air at 1 A/cm² obtained after subjecting various membrane electrode assemblies to corrosion of the cathode catalyst support at 1.4V. The membrane used was a Nafion® N 112, 50 μm and the cathode platinum loading was 0.75 mg/cm².

TABLE 2

| | Carbon loss at | Performance |
|---|---|---|
| Cathode material | cathode | loss |
| 40% Pt on Vulcan XC72R | ˜26 mg | 100% |
| Admixture of Pt black and | ˜2.5 mg | ˜4% |
| 40% Pt/Shawinigan | | |
| TKK TEC50EA10 | ˜3 mg | ˜4% |
| (50% Pt/graphitised carbon) | | |
| TKK TEC50BA10 | ˜5 mg | ˜10% |
| (50% Pt/graphitised carbon) | | |

The admixture of platinum black and supported platinum was in a composition of 30% by weight platinum black and 70% by weight platinum supported on Shawinigan. As the supported catalyst is 40% platinum on Shawinigan, there are approximately equal amounts of platinum black to supported platinum.

Although all of the tested carbon supported catalysts corroded at 1.4V, significant differences were observed regarding the rate of corrosion. Both the admixture of platinum black and supported platinum on Shawinigan and the catalysts supplied by TKK showed considerable improvements in corrosion resistance as compared to supported platinum on Vulcan XC72R. Further, the rate of carbon loss corresponded to significant performance loss with the platinum on Vulcan XC72R showing a 100% performance loss in air over the course of the testing. The admixture and the TKK TEC50EA10 both showed reduced carbon corrosion and reduced performance loss. The reduced carbon corrosion for the admixture may be related, in part, to less carbon being present in the cathode catalyst layer.

All of the supported corrosion resistant catalysts, as well as the admixture, showed comparable initial performance with the same platinum loading. Thus increased corrosion resistance is not necessarily achieved with a corresponding decrease in performance. The above experimental results were obtained with a cathode catalyst coated on a fluid diffusion layer to provide for a cathode fluid diffusion electrode. Similar results would be expected with a catalyst coated membrane though even better performance may be observed due to a better interface between the catalyst and the ion-exchange membrane.

An admixture of platinum black and supported platinum may provide the additional resistance to cathode corrosion as compared to traditional catalysts only comprising carbon supports such as Vulcan XC72R without compromising fuel cell performance. Further such an admixture provides an alternative to catalyst supplied by TKK.

From the foregoing, it will be appreciated that, although specific embodiments of the invention have been described herein for purposes of illustration, various modifications may be made without deviating from the spirit and scope of the invention. Accordingly, the invention is not limited except as by the appended claims.

1. A membrane electrode assembly for an electrochemical fuel cell comprising:
an anode and a cathode fluid diffusion layer;
an ion-exchange membrane interposed between the fluid diffusion layers;
an anode catalyst layer interposed between the anode fluid diffusion layer and the ion-exchange membrane; and
a cathode catalyst layer interposed between the cathode fluid diffusion layer and the ion-exchange membrane, the cathode catalyst layer comprising an admixture of 30-40% by weight platinum black and 60-70% by weight supported catalyst.
